(19) United States
(12) Patent Application Publication
(10) Pub. No.: US 2006/0065793 A1
(43) Pub. Date: Mar. 30, 2006

(54) Brackets for building cushion forts

(76) Inventor: Philip F. Denny, Chicago, IL (US)

Correspondence Address: MCANDREWS HELD & MALLOY, LTD, 500 WEST MADISON STREET, SUITE 3400, CHICAGO, IL, 60661, US

(21) Appl. No.: 11/209,341

(22) Filed: Aug. 23, 2005

Related U.S. Application Data
(60) Provisional application No. 60/603,787, filed on Aug. 23, 2004.

(51) Int. Cl. F16L 3/00

(52) U.S. Cl. 248/121

(57) ABSTRACT

A system for holding furniture cushions to form forts or other structures includes brackets that are sized to engage the edge of one or more cushions. The brackets may include a floor brace to support the bracket and an engaged cushion on the floor. A bracket may be adjustable to positions engaged cushions in a selected configuration.

### RELATED APPLICATIONS

Priority is claimed from provisional application U.S. Ser. No. 60/603,787, filed Aug. 23, 2004 by Philip F. Denny, of Chicago, Ill., now pending. The entire specification and all the claims and drawings of the provisional application referred to above are hereby incorporated by reference to provide continuity of disclosure.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Parents of small children have long known that the common furniture cushion has a higher calling than simply to provide padding between the user of the furniture and the furniture's structure. Furniture cushions make expedient, soft, and safe building blocks for child-sized forts and tunnels. However, as many young architects have discovered, the typical furniture cushion fort tends to separate and fall apart quite easily. The present invention discloses a system of brackets and connectors to strengthen cushion forts, allowing children and adults to build more elaborate and longer-lasting structures.

### BRIEF SUMMARY OF THE INVENTION

According to the present invention, a cushion bracket/connector system comprises a set of brackets of varying configurations that enhances the experience of building cushion forts. Brackets may connect two cushions at a right angle or in a plane or, connect three cushions to create a snug connection between two “wall” cushions and a “roof” cushion. An adjustable angle bracket that positions two cushions at a selectable angle is also within the scope of the invention. Also within the scope of the invention are connectors with bases that provide stability for cushions that are positioned to extend vertically from the floor.

Brackets are made of a material that provides adequate structural support for a cushion while preferably being safe for use by children. The brackets are generally sized to provide good support even for especially flexible or soft cushions.

The brackets according to the present invention may consist of one or more appropriately-sized generally C-shaped structures, designed to hold a sofa cushion in place by engaging opposed surfaces of a cushion, and to allow cushions to be combined in varying numbers and at different angles.

### BRIEF DESCRIPTION OF SEVERAL VIEWS OF THE DRAWINGS

FIG. 1 is an isometric view of the basic right-angle bracket according to the invention for connecting two cushions.

FIG. 2 is an isometric view of the basic right-angle bracket of FIG. 1 in use.

FIG. 3 is an isometric view of a bracket according to the invention for connecting two cushions in a plane.

FIG. 4 is an isometric view of a floor bracket according to the invention supporting up to four cushions perpendicular to the floor.

FIG. 5 is an isometric view of a floor bracket according to the invention for supporting one or more cushions perpendicular to a floor.

FIG. 6 is an isometric view of a floor bracket according to the invention for supporting two cushions at right angles and perpendicular to the floor.

FIG. 7 is an isometric view of an adjustable angle bracket according to the invention.

FIG. 8 is an isometric view of a bracket according to the invention connecting three cushions orthogonally to each other.

FIG. 9 is an isometric view of the bracket shown in FIG. 8 in use.

### DETAILED DESCRIPTION OF THE INVENTION

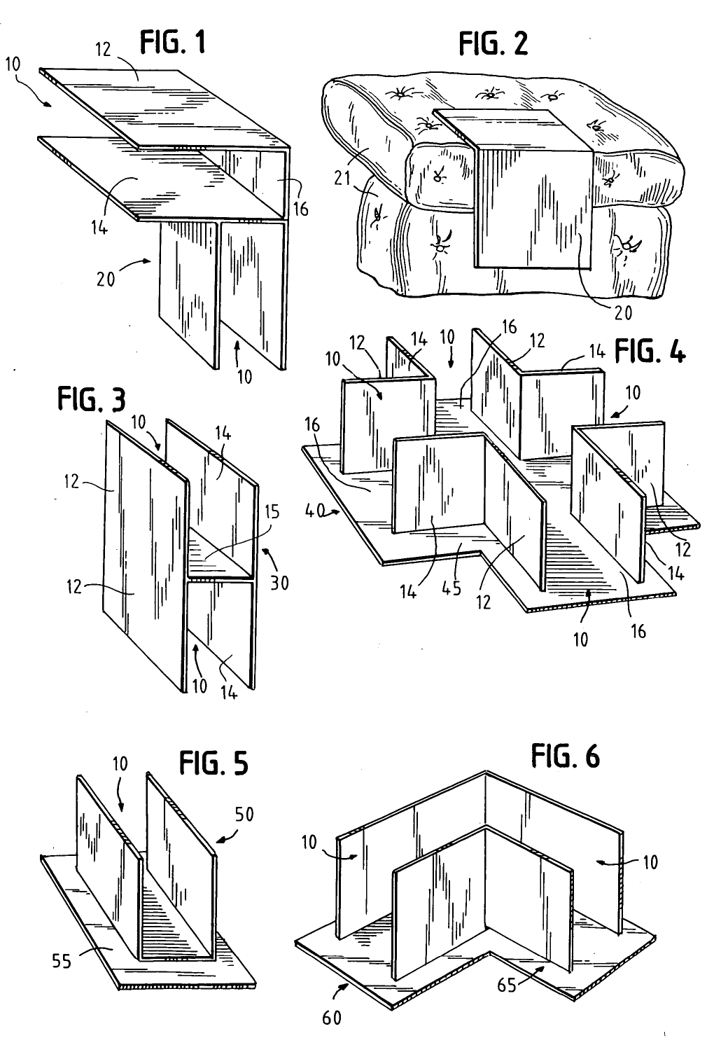

FIG. 1 shows one embodiment of the invention, a cushion bracket 20 engages two cushions and holds them at a right angle to each other. The cushion bracket 20 is formed by two generally C-shaped clamping members 10. Each clamping member 10 has spaced apart parallel walls 12 and 14 that are sized to overlie a section of a cushion and that are separated by a distance that will permit the walls 12 and 14 of clamping member 10 to hold the cushion therebetween. The parallel walls 12 and 14 extend from an end wall 16 to form the generally C-shaped clamping member 10. The parallel walls 12 and 14 are sized to hold and support a cushion that is positioned between the walls 12 and 14 and that extends from the clamping member 10. The end wall 16 of one clamping member 10 is secured to the wall 14 of the other clamping member 10 to form a right angle between the clamping members 10. Alternatively, the cushion bracket 20 could be formed by securing two parallel walls 12 and 14 to a wall 14 of a first clamping member 10 so that the wall 14 of the first clamping member 10 would function as an end wall 16.

The bracket 20 can be used to combine two “wall” cushions of a fort with little separation, or to reinforce a “roof” cushion by connecting it to a “wall” cushion. This is a commonly used embodiment of the invention, since it allows great flexibility in creating cushion structures when multiple brackets are combined with multiple cushions in various configurations. FIG. 2 shows the bracket 20 in use to connect two sofa cushions 21 at a right angle to each other.

Another embodiment of the invention is a bracket 30 for connecting two cushions end-to-end as illustrated in FIG. 3. Similar to the right-angle bracket 20, bracket 30 consists of two clamping members 10 formed having a common end wall, perpendicular separator 15. The two clamping members 10 are formed by two walls 12 and two walls 14 extend oppositely from each other from opposite side of the separator 15. The bracket 30 is particularly useful in connecting two cushions into an extended roof or wall, providing much greater stability and less separation between cushions than was previously possible.

FIG. 4 shows a cruciform floor brace 40, which improves the stability of cushions that are positioned perpendicular to the floor as “wall pieces”. Four clamping members 10 are each formed by separated walls 12 and 14 that extend from and end wall 16. The clamping members 10 are positioned on a floor support 45 so that the end walls 16 are secured to the floor support 45 and the end walls 12 and 14 extend from the floor support 45. The clamping members 10 form right angles to each other. The floor support 45 is wider than the clamping members 10 in order to provide greater stability to wall cushions. In use, the floor brace 40 is placed on the floor with the floor support 45 contacting and overlying the floor and the clamping members 10 opening upwardly away from the floor. A cushion is inserted vertically into the clamping members 10. This configuration allows up to four cushions to be arranged vertically at right angles to each other. The clamping members 10 may be formed by spaced apart parallel walls such as 12 and 14 and an end wall 16 as shown by FIG. 1 or by spaced apart walls secured to and extending from the floor support 45.

Another floor brace 50 for use with one or two cushions is shown in FIG. 5. Similar to the construction of floor brace 40, the floor brace 50 is formed by a clamping member 10 that opens upwardly from the floor from an end wall that is secured to a floor support 55. As shown, the floor support 55 is sized to extend from the clamping member 10 to provide additional stability in supporting a cushion extending upright from the floor brace 50.

Another embodiment providing greater support for “wall” cushions is corner floor brace 60 shown in FIG. 6. Two clamping members 10 are positioned at a right angle to each other to open upwardly from a floor support 65. Each clamping member 10 of corner floor brace 60 accepts a cushion that extends from the floor support 65. The floor support 65 is broad enough to provide added stability to cushions inserted vertically into the clamping members 10.

FIG. 7 shows an adjustable bracket 70 for holding two cushions at an angle that may be adjusted. Two clamping members 10 are connected by an adjustable hinge 75, allowing the bracket to be adjusted to accommodate a variety of angles between cushions. This embodiment is especially useful for creating unusual angles between two “wall” cushions. With creative use of supports (including more cushions connected with another adjustable bracket), this embodiment can be used to create walls at unusual angles relative to the floor.

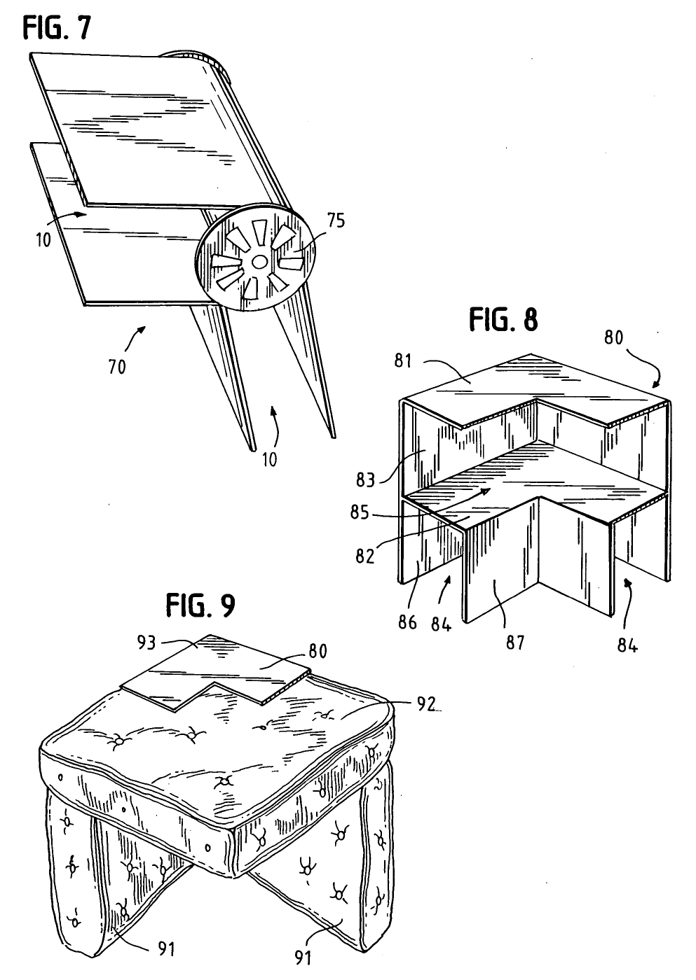

FIG. 8 illustrates a three cushion corner bracket 80 designed to hold three cushions arranged orthogonally and meeting at a common point. The upper chamber 85 is formed by separated generally L-shaped upper wall 81 and generally L-shaped lower wall 82 that extend from corner back wall 83. The lower chamber 84 extends perpendicularly from the lower wall 82 and is formed by right angled members 86 and 87 that extend from and are connected to the lower wall 82. The members 86 and 87 are separated to form an L-shaped lower chamber 84 that accepts a cushion within each leg of the L-shaped chamber 84.

FIG. 9 shows a three cushion corner bracket 80 connecting two vertical cushions 91 extending from the lower chamber 84 and one horizontal cushion 92 extending from the upper chamber 85.

The described embodiments are illustrative of the invention. The invention is not limited to those described embodiments or to described features. Rather the scope of the invention for which a patent is sought is defined solely by the claims to that invention.

I claim:

1. A bracket for connecting furniture cushions to construct child-sized forts and tunnels comprising:
a first clamping member sized and constructed to engage an edge of a furniture cushion;
a second clamping member sized and constructed to engage an edge a furniture cushion; and
the first clamping member connected to the second clamping member to position two furniture cushions adjacent to each other and extending from the bracket.

2. The bracket of claim 1 wherein the clamping members are connected to position two cushions in a generally coplanar relation.

3. The bracket of claim 1 wherein the clamping members are connected at right angles.

4. The bracket of claim 1 wherein the clamping members are connected by an adjustable hinge whereby cushions held by the bracket are held at a selected angle.

5. A floor brace for supporting furniture cushions perpendicular to a floor for use in constructing child-sized forts and tunnels comprising:
a clamping member constructed having an opening that is sized to engage an edge of a furniture cushion an to hold the cushion in a firm stable manner;
a base sized to extend from the clamping member; and
the clamping member secured to the base to open generally away from the base whereby a cushion may be supported extending upwardly from the floor.

6. The floor brace of claim 5 further comprising a second clamping member that is secured to the base at a right angle to the clamping member whereby two cushions can be supported at right angles to each other and generally perpendicular to a floor.

7. The floor brace of claim 5 further comprising a second clamping member, a third, clamping member, and a fourth clamping member, the clamping members positioned in a cruciform configuration whereby up to four cushions can be supported perpendicular to a floor and at right angles to each other.

8. A bracket for connecting furniture cushions to construct child sized forts and tunnels comprising an upper chamber formed by a first and a second generally L-shaped members that are separated from each other and are connected by a perpendicular separator, and a lower chamber extending the second generally L-shaped member, the lower chamber formed by two sets of parallel walls that are at a right angle to each other and that form openings at right angles to each other, the two sets of parallel walls sized to hold two cushions perpendicular to the upper chamber and each other in a firm and stable manner.

9. A method for building a structure of cushions comprising:
providing one or more cushions;
providing a bracket that is sized and constructed to engage a cushion to hold the cushion in a designed position with respect to the bracket;
engaging a cushion with the bracket; and
positioning the cushion at a desired location and in a designed orientation.

10. The method for building a structure of cushions of claim 9 wherein the bracket is constructed to engage two cushions and to hold each cushion in a desired position with respect to the other cushion and the step of engaging a cushion further comprises engaging two cushions.

11. The method for building a structure of cushions of claim 9 wherein the bracket includes a floor support and the step of positioning the cushion includes placing the floor support at a desired location on a floor.
